(19) United States
(12) Patent Application Publication
(10) Pub. No.: US 2026/0109599 A1
(43) Pub. Date: Apr. 23, 2026

(54) PLASMA-CATALYTIC REFORMING OF METHANE AND HYDROGEN SULFIDE INTO HYDROGEN AND POLY CARBON SUBSULFIDE USING NON-THERMAL PLASMA AND SUPPORTED NANOCATALYSTS

(71) Applicant: GERAD TECH., Cachan (FR)

(72) Inventors: Rooholah NOEMANI RAD, Puteaux (FR); Hossein Movla, Tabriz (IR)

(21) Appl. No.: 19/362,892

(22) Filed: Oct. 20, 2025

Related U.S. Application Data
(60) Provisional application No. 63/708,789, filed on Oct. 18, 2024.

(51) Int. Cl. C01B 3/26; B01J 19/08; C01B 32/70

(52) U.S. Cl. CPC C01B 3/26; B01J 19/08; C01B 32/70; B01J 2219/0896; C01B 2203/0277; C01B 2203/06; C01B 2203/0861; C01B 2203/1064; C01B 2203/1082; C01B 2203/1241

(57) ABSTRACT

Systems and methods for converting methane and hydrogen sulfide to hydrogen and poly carbon subsulfide. An exemplary system includes a non-thermal plasma reactor, a first feed stream including methane, a second feed stream including hydrogen sulfide, a catalyst support material selected from boron nitride, carbon black, graphene, aluminum oxide (Al₂O₃) or titanium dioxide TiO₂, and a catalyst selected from Ru, Rh, Ir, Pd, Pt, Re, Mo, Ni, Co, W and combinations thereof. An exemplary method includes providing a first feed stream including methane to a reactor, providing a second feed stream including hydrogen sulfide to the reactor, and reacting the first feed stream and the second feed stream in a non-thermal plasma in the presence of a catalyst to produce a product stream including hydrogen and poly carbon subsulfide.

### CROSS-REFERENCE TO RELATED APPLICATIONS

The present application claims the benefit of U.S. provisional patent application Ser. No. 63/708,789 filed on Oct. 18, 2024, the content of which is incorporated herein by reference in its entirety.

### FIELD

The present disclosure relates to systems and methods for converting methane and hydrogen sulfide to hydrogen and sulfur-rich carbon compounds, including poly carbon subsulfide, by employing plasma-catalytic technology.

### BACKGROUND

Conventional methods like Steam Methane Reforming (SMR) are used to produce hydrogen from fossil fuels. SMR reacts methane with steam at high temperatures and produces hydrogen and significant carbon dioxide (CO₂) emissions. In addition to having high energy costs, SMR dependents on combustion and high-temperature catalysis that increase greenhouse gas emissions. Although alternative “turquoise” hydrogen processes (like methane pyrolysis and methane plasmalysis) avoid producing CO₂ and generate solid carbon, they often cannot handle sulfur-contaminated gas streams and have problems managing carbon, including reactor fouling and solid carbon disposal.

Hydrogen sulfide (H₂S) is a corrosive and toxic byproduct in “sour” natural gas streams. Conventional methods for managing H₂S are based on the Claus process. The Claus process removes H₂S from sour natural gas and converts it into elemental sulfur. Typically, CO₂ and H₂S are sent to the Claus sulfur recovery unit after being scrubbed (for example, by amine absorption) in a gas sweetening operation. The Claus process involves partial oxidation of H₂S to sulfur dioxide (SO₂) and water, and SO₂ catalytically reacted with H₂S to produce elemental sulfur and water (often 95-99+% of H₂S is converted to S). A downside to the Claus process is it consumes the hydrogen content of H₂S and converts the hydrogen to water rather than recovering it as usable hydrogen fuel. Moreover, the CO₂ found in the acid gas feeds is basically wasted because it flows through and is typically vented into the atmosphere.

Carbon disulfide (CS₂) has traditionally been made by reacting hydrocarbons with elemental sulfur at high temperatures (on the order of 1000 K or higher) to achieve good CS₂ yields. However, the reaction is not complete, and H₂S is produced as a byproduct that must be removed. The stoichiometric reaction of methane with elemental sulfur is a good example of this: 2 CH₄+S8→2 CS₂+4 H₂S. So, traditional CS₂ processes have to deal with the sulfur and separate out H₂S, making things more complicated and expensive.

H₂S methane reformation (H₂SMR) directly reforms “sour” gas (methane mixed with H₂S) into hydrogen and CS₂, with the overall reaction of: 2H₂S+CH₄→CS₂+4 H₂. This reaction yields four moles of H₂ per CH₄ (analogous to SMR yields) while producing liquid carbon disulfide which is more desirable than elemental sulfur in solid form. By capturing sulfur in a liquid compound, this process may avoid the problems that the Claus method has with handling solid sulfur. It may also turn H₂S into H₂ gas, which is a useful energy vector. However, the produced CS₂ is typically formed at high temperatures around 600° C. This toxic liquid at boiling state presents both an economic drawback, since liquefaction at such temperatures requires significant energy input, and a safety concern due to the hazardous nature of handling CS₂ under these conditions. Moreover, conventional catalysts are rapidly deactivated by sulfur poisoning.

U.S. Pat. No. 5,211,923, the entire content of which is incorporated herein by reference, describes the use of a plasma discharge to break down H₂S (which may also contain COS, CS₂, or SO₂) into hydrogen and elemental sulfur. That method focuses on breaking down acid gas to get hydrogen and produces an end product of elemental sulfur, which can be either liquid at high temperature or solid. This sulfur needs to be collected, which can be a problem for reactors that need to run continuously as the sulfur can build up or plug them up. The system mostly dealt with H₂S-rich gas. Separately, a non-thermal plasma catalytic method for transforming H₂S and carbon dioxide into hydrocarbons and hydrogen is described in U.S. Pat. No. 12,116,326 B2 (Al-Qahtani et al.). In this system the sulfur from H₂S is extracted as elemental sulfur byproduct, and CO₂ is chemically reduced into hydrocarbons (such as methane or other alkanes) using H₂S as a source of hydrogen. The system generates hydrocarbon fuels and elemental sulfur but not CS₂ or other organosulfur liquids, and is focused on the utilization of CO₂ and the removal of sulfur.

In view of the above prior art, the current method provides for using a catalytic non-thermal plasma reactor to co-convert methane and hydrogen sulfide into hydrogen gas and sulfur-containing carbon compounds such as CS₂ (not elemental sulfur). It does not require oxygen or combustion like the Claus method and does not produce H₂O or CO₂ byproducts. The method uses less energy than traditional thermal reactors by using a non-equilibrium plasma to drive endothermic or otherwise thermodynamically unfavorable reactions at lower temperatures.

In addition, the integration of an appropriate catalyst into the non-thermal plasma zone improves reaction kinetics and selectivity by directing the chemistry toward the intended products (H₂, CS₂ and C₃S₂) and inhibiting undesirable polymeric sulfur deposits or coke (solid carbon). The end result is an integrated process that transforms sulfur into readily recoverable chemical form (CS₂ and related sulfide compounds) instead of elemental sulfur and concurrently produces hydrogen (H₂), thus valorizing the hydrogen content of both CH₄ and H₂S. Because methane can be used without emitting CO₂, H₂S can be processed without producing only inert sulfur waste, and hydrogen is produced without the use of water as a reactant, this combined outcome overcomes the inherent limitations of current hydrogen production and sulfur recovery techniques.

### SUMMARY

This Summary is provided to introduce selected concepts of the disclosure in a simplified form that are further described in detail below. It is not intended to identify key or essential elements of the invention, nor to limit the scope of the claimed subject matter.

One embodiment of the present disclosure is a system for converting methane and hydrogen sulfide to hydrogen and poly carbon subsulfide. The system includes a non-thermal plasma reactor, a first feed stream including methane, a second feed stream including hydrogen sulfide, a catalyst support material selected from boron nitride, carbon black, graphene, aluminum oxide (Al₂O₃) or titanium dioxide TiO₂, and a catalyst selected from Ru, Rh, Ir, Pd, Pt, Re, Mo, Ni, Co, W and combinations thereof.

In aspects, an inlet molar ratio of the methane in the first feed stream to hydrogen sulfide in the second feed stream is between 1:2 to 1:10.

In aspects, a reaction pressure of the reactor is in the range of sub-ambient to two bar absolute pressure.

In aspects, the non-thermal plasma reactor is configured to generate the non-thermal plasma by microwave, radio frequency (RF), dielectric barrier discharge (DBD), gliding arc discharge, or glow discharge methods.

In aspects, a reaction temperature within the reactor is in a range of from about 20 degrees Celsius to about 500 degrees Celsius.

In aspects, the catalyst, according to the present disclosure, includes a Ru nanocluster, and the support material is carbon black.

In aspects, the catalyst includes Pd and Pt nanoparticles and the support material is boron nitride nanotubes.

In aspects, the catalyst includes Ru nanoparticles, and the support material is hexagonal boron nitride (h-BN).

In aspects, the catalyst includes Ru and Ru—Ni nanoparticles, and the support material is TiO₂.

In aspects, the catalyst includes Pd nanoparticles, and the support material is TiO₂ and carbon nanocones.

In aspects, the catalyst includes Co—Ni nanoparticles, and the support material is hexagonal boron nitride (h-BN).

Another embodiment of the present disclosure, includes a method for producing hydrogen and poly carbon subsulfide (C₃S₂)ₓ. The method includes providing a first feed stream including methane to a reactor, providing a second feed stream including hydrogen sulfide to the reactor, and reacting the first feed stream and the second feed stream in a non-thermal plasma in the presence of a catalyst to produce a product stream including hydrogen and poly carbon subsulfide. The catalyst includes a catalyst support material selected from boron nitride, carbon black, graphene, aluminum oxide (Al₂O₃) or titanium dioxide TiO₂ and the catalyst is selected from Ru, Rh, Ir, Pd, Pt, Re, Mo, Ni, Co, W and combinations thereof.

In aspects the method further includes providing the product stream to a separator and separating the product stream into a hydrogen stream and a poly carbon subsulfide stream.

In aspects the method further includes separating the product stream into a hydrogen stream and a poly carbon subsulfide stream by cooling the product stream to produce a condensed portion of the product stream.

In aspects the separator separates the products stream into a hydrogen stream, a poly carbon subsulfide stream, and an unreacted gases stream that includes unreacted methane, and hydrogen sulfide, and the method further includes providing the unreacted gases stream to a second reactor, reacting the unreacted gases stream in a second non-thermal plasma in the presence of a second catalyst to produce a second product stream including hydrogen and poly carbon subsulfide. The second catalyst includes a second catalyst support material selected from boron nitride, carbon black, graphene, aluminum oxide (Al₂O₃) or titanium dioxide TiO₂ and the second catalyst is selected from Ru, Rh, Ir, Pd, Pt, Re, Mo, Ni, Co, W and combinations thereof.

In aspects the method further includes providing the second product stream to a second separator and separating the second product stream into a second hydrogen stream and a second poly carbon subsulfide stream.

In aspects the method further includes separating the second product stream into a second hydrogen stream and a second poly carbon subsulfide stream by cooling the second product stream to produce a condensed portion of the second product stream.

In aspects the catalyst includes Co—Ni nanoparticles, and the support material is hexagonal boron nitride (h-BN), and the second catalyst includes Ru and Ru—Ni nanoparticles, and the second support material is TiO₂.

In aspects the method further includes preheating the first feed stream prior to providing the first feed stream to the reactor.

Another embodiment of the present disclosure includes a catalyst on a support for converting methane and hydrogen sulfide to hydrogen and poly carbon subsulfide in the presence of a non-thermal plasma. The catalyst on a support includes a catalyst support material selected from boron nitride, carbon black, graphene, aluminum oxide (Al₂O₃) or titanium dioxide TiO₂ and the catalyst is selected from Ru, Rh, Ir, Pd, Pt, Re, Mo, Ni, Co, W and combinations thereof.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

A detailed description of specific exemplary embodiments is provided herein below with reference to the accompanying drawings in which:

FIG. 1 illustrates a reactor system for a plasma-catalytic hydrogen sulfide methane reforming process arranged according to at least some embodiments described herein;

FIG. 2 is a flow diagram of a non-thermal plasma catalytic process arranged according to at least some embodiments described herein;

FIG. 3 illustrates a two-stage reactor for plasma-catalytic hydrogen sulfide methane reforming process arranged according to at least some embodiments described herein; and

FIG. 4 is a non-limiting example of a non-thermal plasma catalytic process arranged according to at least some embodiments described herein.

In the drawings, exemplary embodiments are illustrated by way of example. It is to be expressly understood that the description and drawings are only for the purpose of illustrating certain embodiments and are an aid for understanding. They are not intended to be a definition of the limits of the disclosure.

### DETAILED DESCRIPTION

The present technology is explained in greater detail below. This description is not intended to be a detailed catalog of all the different ways in which the technology may be implemented or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art, considering the instant disclosure, which variations and additions do not depart from the present technology. Hence, the following description is intended to illustrate some embodiments of the technology and not to specify all permutations, combinations, and variations thereof exhaustively.

The present disclosure relates to a non-thermal plasma catalytic process or method for converting methane and hydrogen sulfide to hydrogen and poly carbon subsulfide ((C₃S₂)ₓ) and corresponding systems. Plasma-catalytic hydrogen sulfide methane reforming may be a process where hydrogen sulfide is converted into hydrogen gas by reacting with methane in the presence of a catalyst, while utilizing a plasma to activate the reaction and significantly increase its efficiency. The process may simultaneously valorize H₂S (a waste product) and produce hydrogen, with the plasma acting as an energy source to drive the chemical reaction at lower temperatures and potentially with more valuable yields than traditional methods. When the methane and hydrogen sulfide feed streams are introduced into the reactor vessel and the plasma generated, the reforming system operates under non-equilibrium plasma conditions. In this condition, methane and hydrogen sulfide molecules dissociated into reactive species, and then interacted on the catalyst surfaces in the gas phase. The primary intended reaction can be represented as:

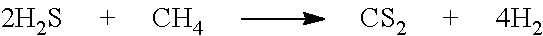

yielding carbon disulfide (CS₂) and hydrogen (H₂) as main products.

In practice, the plasma catalytic reactor products will contain hydrogen gas and one or more carbon-sulfur compounds, and when the feed streams ratio, the plasma, and the catalyst conditions are optimized, carbon-sulfur compounds may be primarily CS₂. The process may also produce minor co-products such as tricarbon disulfide (C₃S₂) and other higher carbon-sulfur species under certain conditions. For example, it is known that carbon subsulfide (C₃S₂) can form by polymerization of CS₂ in an electric discharge, so a fraction of C₃S₂ (a deep red liquid) might be generated in the plasma alongside CS₂. Any unreacted methane or hydrogen sulfide and trace byproducts (e.g. elemental sulfur vapor, carbon solids, or other hydrocarbons) may be separated downstream, with unreacted gases potentially recycled to improve overall conversion efficiency.

The product streams resulting from the process may be managed. Hydrogen gas produced may be separated into a gaseous product stream, ready for collection, purification, or on-site use (for instance, as fuel for electricity generation or as feedstock for ammonia synthesis, etc.). The sulfur-containing carbon products like CS₂ and C₃S₂ condense at ambient conditions are in a liquid form, facilitating their removal from the gas. In fact, the system may include condensers or scrubbing units to cool the reactor effluent and recover CS₂ as a liquid product. By converting sulfur into CS₂ (boiling point ˜46° C.) rather than solid elemental sulfur, the process inherently avoids the fouling and plugging issues associated with sulfur deposition inside the reactor. The CS₂ can be drawn off and stored or sold as a chemical commodity. Notably, this approach preserves the hydrogen content of H₂S: instead of being wasted as water (as in the Claus method or other oxidative processes), that hydrogen is released as hydrogen gas, contributing to a more hydrogen-rich product output. The overall chemical efficiency is high-every mole of methane yields up to four moles of hydrogen analogous to conventional reforming, but without producing carbon dioxide and while simultaneously disposing of hydrogen sulfide in a useful manner.

The process may employ a combination of non-thermal plasma and a catalyst. The process enhances conversion efficiency and selectivity, reduces greenhouse gas emissions, and lowers operational costs. The catalysts are designed to resist high temperatures without deactivation due to sulfur poisoning or carbon formation. The plasma generates activated methane and hydrogen sulfide fragments even at moderate bulk temperatures, overcoming the thermodynamic barriers that normally necessitate >1000 degree Celsius for CS₂ formation.

Certain aspects of the present disclosure described can be implemented as a method. Feed streams may be provided or flowed to the first plasma catalytic reactor. The first plasma catalytic reactor includes a first non-thermal plasma and a first catalyst. The feed streams include methane and hydrogen sulfide. The feed streams are contacted with the catalyst in the presence of the non-thermal plasma at a reaction temperature, thereby converting the methane and hydrogen sulfide in the feed streams to produce products. The products include hydrogen and carbon-sulfur compounds.

In some embodiments, the methane and hydrogen sulfide plasma catalytic reforming unit is followed by the addition of a secondary plasma catalytic reforming unit, converting remaining unreacted gas compounds into hydrogen and carbon-sulfur compounds.

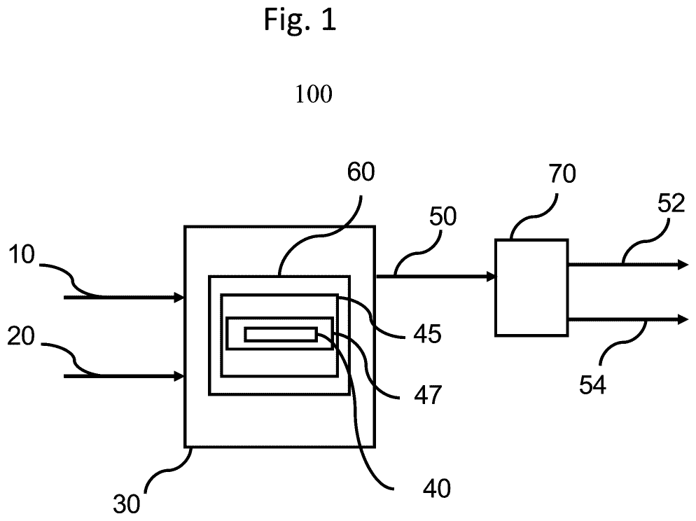

FIG. 1 illustrates a reactor system for a plasma-catalytic hydrogen sulfide methane reforming process, according to the present disclosure and arranged in accordance with at least some embodiments described herein. System 100 may include a first feed stream 10, a second feed stream 20, a-reactor 30, a catalyst 40, a product stream 50, and a separation unit 70.

First feed stream 10 may be methane (CH₄) and may be sourced from natural gas, biogas, sour gas, landfills and wastewater treatment processes or methane-rich industrial waste streams. First feed stream 10 may be pure CH₄ or “sweetened” natural gas or a highly methane-rich stream, including “sour” natural gas that contains hydrogen sulfide. First feed stream 10 may be dry gas. In some embodiments, first feed stream 10 may be preheated or mixed with a carrier gas (for example, nitrogen). Second feed stream 20 may be hydrogen sulfide (H₂S) and may be introduced into reactor 30 with or without pe-heating or may include an inert gas such as nitrogen, neon, or argon. Hydrogen sulfide in second feed stream 20 may be a byproduct found in industries like oil and gas refining, chemical manufacturing, and waste treatment processes. Second feed stream 20 may be dry gas. A desired molar ratio of first feed stream 10 and second feed stream 20 (CH₄:H₂S) may be around 1:4 or higher to maximize sulfur-containing carbon products and to prevention the formation of free carbon. In certain embodiments, the first and second feed streams 10 and 20 may be premixed, especially if first feed stream 10 includes sour gas or a mixture of carrier gases. First feed stream 10 and second feed stream 20 may be provided to reactor 30 by independent feed lines each equipped with a digitally controlled mass-flow controller.

Reactor 30 may be a reactor vessel contained with a non-thermal plasma source to generate a non-equilibrium plasma 60 in a reaction zone of reactor 30. Reactor 30 may operate from sub-ambient to two bar absolute pressure, and may include actively cooled electrodes and real-time voltage/current diagnostics for power measurement. Reactor 30 may include vacuum-tight fittings, pressure regulation, and gas chromatographic analysis of effluents.

Reactor 30 may be a non-thermal plasma catalytic reactor and may be configured to utilize an electrical discharge to create an ionized non-thermal plasma 60 between two electrodes separated by an insulating barrier within reactor 30 at a relatively low temperature. Non-thermal plasma 60 may provide energetic electrons, ions, reactive radicals, excited intermediates and active species of feed gases within reactor 30 with or without pe-heating of reactor 30. Free electrons associated with the ions of ionized non-thermal plasma 60 may react with chemicals from feed stream 10 and feed stream 20 within reactor 30 and convert the chemicals to oxidized forms. Non-thermal plasma 60 may be generated using microwave, radio frequency (RF), dielectric barrier discharge (DBD), gliding arc discharge, or glow discharge methods. The energy input into non-thermal plasma 60 may be controlled to initiate and sustain the reaction within reactor 30 without requiring excessive heat.

Non-thermal plasma 60 may be a plasma that is not in thermodynamic equilibrium. Non-thermal plasma 60 may not be in thermodynamic equilibrium because the temperature of the electrons in non-thermal plasma 60 may be much greater than the temperature of the ions, neutrals or heavy species within non-thermal plasma 60.

In some embodiments, reactor 30 includes analytical and control systems for monitoring plasma voltage, current, pressure, and product composition in real time.

In some implementations, the feed streams 20 and 30 also include a gas that is used to facilitate generation of the non-thermal plasma 60. For example, feed stream 20 may include an inert gas such as nitrogen, neon, or argon.

Catalyst 40 may be included in a catalyst bed 45 or a coated substrate which may enhance a reaction efficiency and selectivity between methane of feed stream 10 and hydrogen sulfide of feed stream 20. Catalyst 40 may lower the activation energy for the reaction of methane of feed stream 10 and hydrogen sulfide of feed stream 20. Catalyst 40 may include noble metals such as Ru, Rh, Ir, Pd, Pt, Re and non-noble metals such as Mo, Ni, Co, W and combinations thereof.

Catalyst 40 may be resistant in a temperature range of about 700° C. to about 1300° C. Catalyst 40 may include a catalyst support material 47 which may be an inorganic or carbonaceous substrate and may enhance selectivity, performance and durability of catalyst 40. Catalyst support material 47 may include carbon black, boron nitride, graphene, aluminum oxide (Al₂O₃), or titanium dioxide (TiO₂) and combinations thereof. Catalyst support material 47 may have a specific structure such as mesoporous, may include nanotubes, may include nanocones, and/or may include embedding two layers.

In an embodiment, catalyst 40 may include a Ru nanocluster catalyst supported on a carbon black catalyst support material 47. In another embodiment, catalyst 40 may include Pd and Pt nanoparticles supported on boron nitride nanotubes catalyst support material 47. In another embodiment, catalyst 40 may include Ru nanoparticles supported on hexagonal boron nitride (h-BN) catalyst support material 47. In another embodiment, catalyst 40 may include Ru and Ru—Ni nanoparticles supported on TiO₂ catalyst support material 47. In another embodiment, catalyst 40 may include Pd nanoparticles supported on TiO₂ and carbon nanocones catalyst support material 47. In another embodiment, catalyst 40 may include Co—Ni nanoparticles encapsulated within hexagonal boron nitride (h-BN) catalyst support material 47.

Within reactor 30 the following reactions may occur:

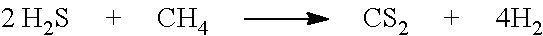

(in plasma conditions with a C₃S₂ co-product)

Reactor 30 may generate 2 moles of H₂ and 0.5 mol of CS₂ per 1 mol of H₂S reacted with 0.5 mol of CH₄.

Within reactor 30, methane from feed stream 10 may react with hydrogen sulfide from feed stream 20 under the influence of non-thermal plasma 60 and catalyst 40 resulting in the formation of hydrogen and carbon-sulfur compounds. Non-thermal plasma 60 may catalyze the reactants by generating electrons in free radicals and ions that interact with methane and hydrogen sulfide and open up new reaction pathways. This may be due to a non-equilibrium environment created within non-thermal plasma 60. Non-thermal plasma 60 may also lower a reaction barrier to the formation of condensed matter including poly carbon subsulfide, (C₃S₂)ₓ by the following equations:

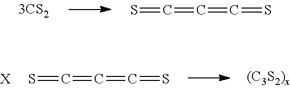

Product stream 50 may include poly carbon subsulfide, (C₃S₂)ₓ which may have a higher commercial value than CS₂. (C₃S₂)ₓ may exhibit semiconducting behavior and have electronic properties determined by various characterization techniques, including X-ray diffraction, electrical conductivity measurements, and optical absorption spectroscopy. (C₃S₂)ₓ may have a bandgap of about 2.4 eV, which may be in the range of typical semiconductor materials. (C₃S₂)ₓ may also have semiconducting behavior including potential use in electronic and optoelectronic applications such as field-effect transistors and photovoltaic devices.

Reactants from feed stream 10 and feed stream 20 may have a residence time of about 1 second to about 3 seconds within reactor 30 and may flow for a single pass though reactor 30. Catalyst 40 may have a time on stream (TOS) of about 1 hour. A pressure within reactor 30 may be about 1 atmosphere, a temperature within reactor 30 may be about 500° C. or lower, and the reaction may be adiabatic. Non-thermal plasma 60 may lower an energy barrier for the reactions of feed stream 10 and feed stream 20 so that catalyst 40 may perform effectively at temperatures or about 500° C. or lower because high-energy electrons and plasma radicals of non-thermal plasma 60 may provide the necessary activation energy. While a temperature of the bulk gas in reactor 50 may be about 20° C. to 500° C. or lower, a localized energy input from non-thermal plasma 60 may allow catalyst 40 to function effectively within its active temperature range due to catalyst 60 being activated through plasma-generated hot electrons, ions, and radicals, which may provide the necessary energy to drive the reactions at lower bulk temperatures. Non-thermal plasma 60 may enable high conversion rates and catalyst 40 efficiency despite a lower overall reactor temperature.

Product stream 50 may include both gaseous and liquid components. Product stream 50 may include up to about 70-80% by volume hydrogen with the balance CS₂ and C₃S₂. Specific production ratios may be dependent on the reaction conditions.

Product stream 50 may be fed to a separation unit 70. Separating unit 70 may separate product stream 50 to hydrogen stream 52 and poly carbon subsulfides stream 54.

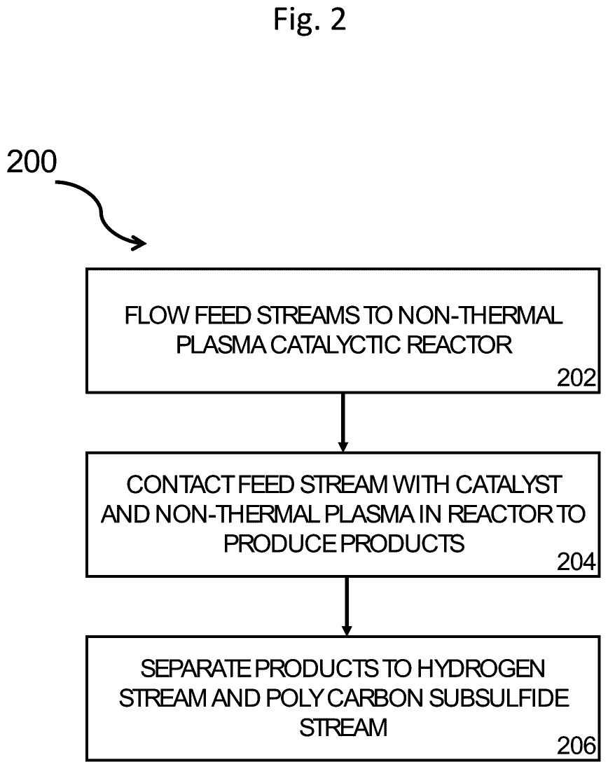

FIG. 2 is a is a flow chart of an example method 200 for converting methane and hydrogen sulfide to the hydrogen and carbon-sulfur compounds. The system 100 can implement the method 150.

At block 202 a feed streams (such as the feed streams 10 and 20) are provided or flowed to a plasma catalytic reactor 30. As mentioned previously, feed stream 10 includes methane and feed stream 20 includes hydrogen sulfide. Reactor 30 includes catalyst 40 and the non-thermal plasma 60. In some implementations, a volumetric ratio of the methane in feed stream 10 to hydrogen sulfide in feed stream 20 is about 1:4 or more.

At block 204, the feed streams 10 and 20 are contacted with catalyst 40 in the presence of non-thermal plasma 60 within plasma catalytic reactor 30. At block 204 feed streams 10 and 20 are contacted with catalyst 40 in the presence of non-thermal plasma 60 at a reaction temperature that is in a range of from about 20° C. to about 500° C. Contacting feed streams 10 and 20 with catalyst 40 in the presence of the non-thermal plasma 60 at block 204 results in converting the methane and hydrogen sulfide in the feed streams 10 and 20 to produce a product 50. As mentioned previously, the product 50 includes hydrogen and poly carbon subsulfide. In some implementations, the reaction pressure is in the range of sub-ambient to two bar absolute pressure.

At block 206, the product 50 is separated in separation unit 70 into product streams 52 (hydrogen stream) and 54 (poly carbon subsulfide). In some implementations, separating product 50 into hydrogen stream 52 and poly carbon subsulfide stream 54 at block 206 includes cooling the product 50, such that a portion of product 50 is condensed. In such implementations, the condensed portion of product stream 50 is the poly carbon subsulfide stream 54. As mentioned previously, product stream 50 includes the hydrogen and poly carbon subsulfide derived from the reactions of feed streams 10 and 20 within reactor 30. In some embodiments, poly carbon subsulfide stream 54 includes carbon-sulfur compounds, such as CS₂, C₃S₂, or (C₃S₂)ₓ.

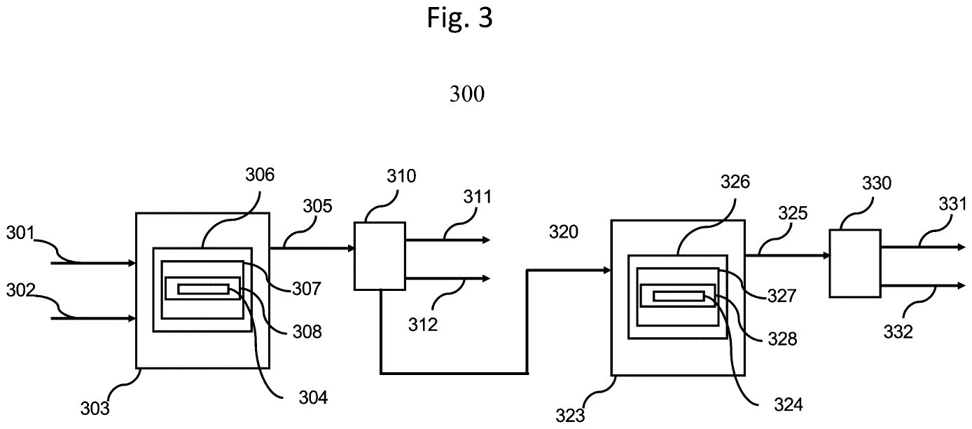

FIG. 3 illustrates a reactor system for a two-stage plasma-catalytic hydrogen sulfide methane reforming process, according to the present disclosure and arranged in accordance with at least some embodiments described herein. System 300 may include a first feed stream 301, a second feed stream 302, a first reactor 303, a first catalyst 304, a first product stream 305, a first separation unit 310, a hydrogen stream 312, a poly carbon subsulfide stream 312, an unreacted gases stream 320, a second reactor 323, a second catalyst 324, a second product stream 325, a second separation unit 330, a second hydrogen stream 331, and a second poly carbon subsulfide stream 332.

First feed stream 301 may be methane (CH₄) and may be sourced from natural gas, biogas, sour gas, landfills and wastewater treatment processes or methane-rich industrial waste streams. First feed stream 301 may be dry gas. Second feed stream 302 may be hydrogen sulfide (H₂S). Hydrogen sulfide in second feed stream 302 may be a byproduct found in industries like oil and gas refining, chemical manufacturing, and waste treatment processes. Second feed stream 302 may be dry gas.

First reactor 303 may be configured to utilize an electrical discharge to create an ionized first non-thermal plasma 306 between two electrodes separated by an insulating barrier within first reactor 303 at a relatively low temperature. Free electrons associated with the ions of the ionized first non-thermal plasma 306 may react with chemicals from first feed stream 301 and second feed stream 302 within first reactor 303 and convert the chemicals to oxidized forms. First non-thermal plasma 306 may be generated using microwave, radio frequency (RF), dielectric barrier discharge (DBD), gliding arc discharge, or glow discharge methods. The energy input into first non-thermal plasma 306 may be controlled to initiate and sustain the reaction without requiring excessive heat.

First non-thermal plasma 306 may be a plasma that is not in thermodynamic equilibrium. First non-thermal plasma 306 may not be in thermodynamic equilibrium because the temperature of the electrons in the first non-thermal plasma 306 may be much greater than the temperature of the ions, neutrals or heavy species.

In some implementations according to the present disclosure, first feed stream 301 and second feed stream 302 may include a gas that is used to facilitate generation of first non-thermal plasma 306. For example, second feed stream 302 may include an inert gas (such as nitrogen, neon, or argon) which may be used to generate first non-thermal plasma 306.

First catalyst 304 may be included in a first catalyst bed 307 and may enhance a reaction efficiency and selectivity between methane of first feed stream 301 and hydrogen sulfide of second feed stream 302. The first catalyst 304 may lower the activation energy for the reaction of methane of first feed stream 301 and hydrogen sulfide of second feed stream 302. The first catalyst 304 may include noble metals such as Ru, Rh, Ir, Pd, Pt, Re and non-noble metals such as Mo, Ni, Co, W and combination thereof.

First catalyst 304 may be resistant in a temperature range of about 700° C. to about 1300° C. First catalyst 304 may include a first catalyst support material 308 which may enhance selectivity, performance and durability of first catalyst 304. First catalyst support material 308 may include carbon black, boron nitride, graphene, aluminum oxide (Al₂O₃), titanium dioxide TiO₂ and combinations thereof. First catalyst support material 308 may have a specific structure and may be mesoporous, may include nanotubes, may include nanocones, and may include embedding two layers.

In an embodiment according to the present disclosure, the first catalyst 304 may include a Ru nanocluster catalyst supported on a carbon black first catalyst support material 308. In another embodiment, the first catalyst 304 may include Pd and Pt nanoparticles supported on boron nitride nanotubes catalyst support material 308. In another embodiment, the first catalyst 304 may include Ru nanoparticles supported on hexagonal boron nitride (h-BN) first catalyst support material 308. In another embodiment, the first catalyst 304 may include Ru and Ru—Ni nanoparticles supported on TiO₂ first catalyst support material 308. In another embodiment, catalyst 40 may include Pd nanoparticles supported on TiO₂ and carbon nanocones first catalyst support material 308. In another embodiment, the first catalyst 304 may include Co—Ni nanoparticles encapsulated within hexagonal boron nitride (h-BN) first catalyst support material 307.

Within first reactor 303 the following reactions may occur:

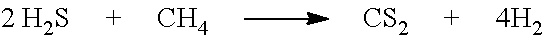

(in plasma conditions with a C₃S₂ co-product)

The first reactor 303 may generate 2 moles of H₂ and 0.5 mol of CS₂ per 1 mol of H₂S reacted with 0.5 mol of CH₄, and a portion of unreacted gases as unreacted gases stream 320.

Within first reactor 303, methane from feed stream 301 may react with hydrogen sulfide from feed stream 302 under the influence of first non-thermal plasma 306 resulting in the formation of hydrogen and carbon-sulfur compounds. First product stream 305 may include unreacted components of first feed stream 301 and second feed stream 302, hydrogen, and carbon-sulfur compounds.

First product stream 305 may also include poly carbon subsulfide, (C₃S₂)ₓ, which may have a higher commercial value than CS₂.

Reactants from feed stream 301 and feed stream 302 may have a residence time of about 1 second to about 3 seconds within first reactor 303 and may flow for a single pass. The first catalyst 304 may have a time on stream (TOS) of about 1 hour. A pressure within first reactor 303 may be about 1 atmosphere, a temperature within first reactor 303 may be about 500° C. or lower, and the reaction may be adiabatic. First non-thermal plasma 306 may lower an energy barrier for the reactions of first feed stream 301 and second feed stream 302 so that first catalyst 304 may perform effectively at lower temperatures due to high-energy electrons and plasma radicals from first non-thermal plasma 306 which may provide the necessary activation energy to the system. While a temperature of the bulk gas in first reactor 303 may be about 20° C. to 500° C. or lower, a localized energy input from first non-thermal plasma 306 may allow first catalyst 304 to function effectively within an active temperature range due to first catalyst 304 being activated through plasma-generated hot electrons, ions, and radicals, which may provide the necessary energy to drive the reactions at lower bulk temperatures. First non-thermal plasma 306 may enable high conversion rates and first catalyst 304 efficiency at a lower overall reactor temperature.

First product stream 305 may include both gaseous and liquid components. First product stream 305 may include up to about 70-80% by volume hydrogen and the balance may be CS₂ and C₃S₂. Specific production ratios may be dependent on the reaction conditions.

First product stream 305 may be supplied to separation unit 310. Separation unit 310 may separate first product stream 305 to hydrogen stream 311, poly carbon subsulfides stream 312, and unreacted gases stream 320. Unreacted gases stream 320 may be supplied as a feed stream to second reactor 323.

Second reactor 323 may be configured to utilize an electrical discharge to create an ionized second non-thermal plasma 326 between two electrodes separated by an insulating barrier within second reactor 323 at a relatively low temperature. Free electrons associated with the ions of the ionized second non-thermal plasma 326 may react with chemicals from unreacted gases stream 320 within second reactor 323 and convert the chemicals to oxidized forms. Second non-thermal plasma 326 may be generated using microwave, radio frequency (RF), dielectric barrier discharge (DBD), gliding arc discharge, or glow discharge methods. The energy input into second non-thermal plasma 326 may be controlled to initiate and sustain the reaction without requiring excessive heat.

Second non-thermal plasma 326 may be a plasma that is not in thermodynamic equilibrium. Second non-thermal plasma 326 may not be in thermodynamic equilibrium because a temperature of the electrons in the second non-thermal plasma 326 may be greater than a temperature of the ions, neutrals or heavy species.

Second catalyst 324 may be included in a second catalyst bed 327 and may enhance a reaction efficiency and selectivity between unreacted gases from methane and hydrogen sulfide of unreacted gases stream 320. Second catalyst 324 may lower the activation energy for the reaction of unreacted gases from methane and hydrogen sulfide of unreacted gases stream 320. Second catalyst 324 may include noble metals such as Ru, Rh, Ir, Pd, Pt, Re and non-noble metals such as Mo, Ni, Co, W and combination thereof.

Second catalyst 324 may be resistant in a high temperature range of about 700° C. to about 1300° C. Second catalyst 324 may include a catalyst support material 328 which may enhance selectivity, performance and durability of second catalyst 324. Second catalyst support material 328 may include carbon black, boron nitride, graphene, aluminum oxide (Al₂O₃), TiO₂ and combination thereof. Second catalyst support material 328 may have a specific structure and may be mesoporous, may include nanotubes, may include nanotubes, may include nanocones, and may include embedding two layers.

In an embodiment, second catalyst 324 may include a Ru nanocluster catalyst supported on a carbon black second catalyst support material 328. In another embodiment, second catalyst 324 may include Pd and Pt nanoparticles supported on boron nitride nanotubes second catalyst support material 328. In another embodiment according to the present disclosure, second catalyst 324 may include Ru nanoparticles supported on hexagonal boron nitride (h-BN) second catalyst support material 328. In another embodiment, second catalyst 324 may include Ru and Ru—Ni nanoparticles supported on TiO₂ second catalyst support material 328. In another embodiment, second catalyst 324 may include Pd nanoparticles supported on TiO₂ and carbon nanocones second catalyst support material 328. In another embodiment, second catalyst 324 may include Co—Ni nanoparticles encapsulated within hexagonal boron nitride (h-BN) second catalyst support material 328.

Within second reactor 323 the following reactions may occur:

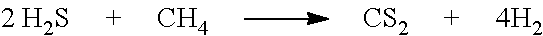

(in plasma conditions with a C₃S₂ co-product)

Within second reactor 323, unreacted gases from first reactor 303 may react together under the influence of second non-thermal plasma 326 resulting in the formation of hydrogen, and carbon-sulfur compounds.

The second product stream 325 may include poly carbon subsulfide, (C₃S₂)ₓ which may have a higher commercial value than CS₂.

Reactants from unreacted gases stream 320 may have a residence time of about 1 second to about 3 seconds within second reactor 323 and may flow for a single pass. The second catalyst 324 may have a time on stream (TOS) of about 1 hour. A pressure within second reactor 323 may be about 1 atmosphere, a temperature within second reactor 323 may be about 500° C. or lower, and the reaction may be adiabatic. The second non-thermal plasma 326 may lower an energy barrier for the unreacted gases from unreacted gases stream 320 so that the second catalyst 324 may perform effectively at lower apparent temperatures because the high-energy electrons and plasma radicals of second non-thermal plasma 326 may provide the necessary activation energy. While a temperature of the bulk gas in second reactor 323 may be about 20° C. to 500° C. or lower, a localized energy input from second non-thermal plasma 326 may allow the second catalyst 324 to function effectively within an active temperature range due to the second catalyst 324 being activated through plasma-generated hot electrons, ions, and radicals, which provide energy to drive the reactions at lower bulk temperatures. Second non-thermal plasma 326 may enable high conversion rates and second catalyst 324 efficiency despite a lower overall reactor temperature.

Second product stream 325 may include both gaseous and liquid components. Second product stream 331 may include up to about 70-80% by volume hydrogen with the balance CS₂ and C₃S₂. Specific production ratios may be dependent on the reaction conditions.

Separation unit 330 may separate the first product stream 325 to second hydrogen stream 331 and second poly carbon subsulfides stream 332.

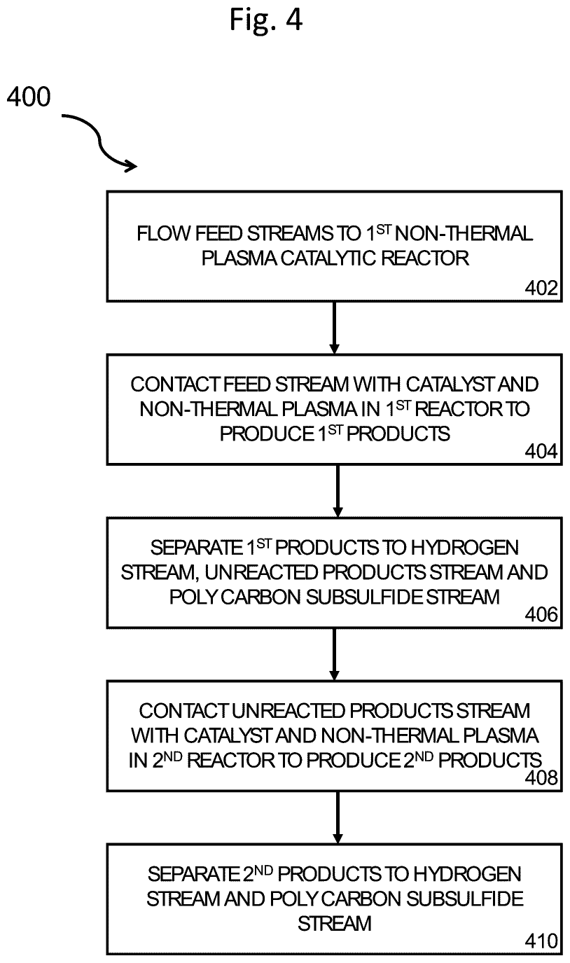

FIG. 4 is a flow chart of an example method 400 for converting methane and hydrogen sulfide to the hydrogen and carbon-sulfur compounds. The method 400 may be implemented by system 300.

At block 402 feed streams (such as the feed streams 301 and 302) are provided or flowed to first plasma catalytic reactor 303. As mentioned previously, the feed stream 301 includes methane and feed stream 302 includes hydrogen sulfide, and the first plasma catalytic reactor 303 includes the first catalyst 304 and the first non-thermal plasma 306. In some implementations, the molar ratio of the methane to hydrogen sulfide in the feed stream is about 1:4 or more.

At block 404, the first feed streams 301 and 302 are contacted with the first catalyst 304 in the presence of the first non-thermal plasma 306 within the first plasma catalytic reactor 303. At block 404 the feed streams 301 and 302 are contacted with the first catalyst 304 in the presence of the first non-thermal plasma 306 at a reaction temperature that is in a range of from about 20° C. to about 500° C. Contacting the feed streams 301 and 302 with the first catalyst 304 in the presence of the first non-thermal plasma 306 at block 404 results in converting the methane and hydrogen sulfide in the feed streams 301 and 302 to produce a first product stream 305. As mentioned previously, the first product stream 305 includes a hydrogen and poly carbon subsulfide and a portion of unreacted gases. In some implementations, the reaction pressure is in the range of sub-ambient to two bar absolute pressure.

At block 406, the first product stream 305 is separated in separation unit 310 into product stream 311 (hydrogen stream), stream 312 (poly carbon subsulfide), and unreacted gases stream 320. In some implementations, separating the first product stream 305 into hydrogen stream 311, poly carbon subsulfide stream 312, and unreacted gases stream 320 at block 406 includes cooling the first product stream 305, such that a portion of the first product stream 305 is condensed. In such implementations, the condensed portion of first product stream 305 is the poly carbon subsulfide stream 312. As mentioned previously, first product stream 305 includes hydrogen, poly carbon subsulfide, and unreacted gases from first feed stream 301 and second feed stream 302. In some embodiments, first product stream 305 further includes carbon-sulfur compounds, such as CS₂, C₃S₂, or (C₃S₂)ₓ.

At block 408 unreacted gases stream 320 is provided or flowed to a second reactor 323. As mentioned previously, unreacted gases stream 320 includes hydrogen and hydrogen sulfide, and second reactor 323 includes second catalyst 324 and second non-thermal plasma 326. At block 408 the unreacted gases stream 320 is contacted with the second catalyst 324 in the presence of the second non-thermal plasma 326 at a reaction temperature that is in a range of from about 20° C. to about 500° C. Contacting the unreacted gases stream 320 with second catalyst 324 in the presence of second non-thermal plasma 326 at block 408 results in converting the methane and hydrogen sulfide in the unreacted gases stream 320 to produce a second product stream 325. As mentioned previously, the second product stream 325 includes hydrogen and poly carbon subsulfide. In some implementations, a reaction pressure of second reactor 323 is in the range of sub-ambient to two bar absolute pressure.

At block 410, second product stream 325 is provided to separation unit 330 and separated into product streams, hydrogen stream 331 and poly carbon subsulfide stream 332. In some implementations, separating second product stream 325 into hydrogen stream 331 and poly carbon subsulfide stream 332 at block 410 includes cooling second product stream 325, such that a portion of second product stream 325 is condensed. In such implementations, the condensed portion of second product stream 325 is poly carbon subsulfide stream 332. As mentioned previously, the second product stream 325 includes hydrogen and poly carbon subsulfide produced from unreacted gases feed stream 320. In some embodiments, product stream 325 further includes carbon-sulfur compounds, such as CS₂, C₃S₂, or (C₃S₂)ₓ.

### EXAMPLES

The following Examples are provided to illustrate some of the concepts described within this disclosure. While each Example is considered to provide specific individual embodiments of composition, methods of preparation and use, none of the Examples should be considered to limit the more general embodiments described herein.

In the following examples, efforts have been made to ensure accuracy with respect to numbers used (e.g. amounts, temperature, etc.) but some experimental error and deviation should be accounted for. Unless indicated other-wise, temperature is in degrees K.

Over the course of the examples, all experiments were conducted in a bench-scale reactor vessel contained with a non-thermal plasma source (for example, a dielectric barrier discharge (DBD), radio frequency (RF), microwave, glow discharge or gliding arc plasma source) to generate a non-equilibrium plasma in the reaction zone of the reactor. In the following experiment, the plasma source was generated using a resonant AC discharge circuit tunable from 50-160 kHz. Peak voltage and plasma power are reported in each Example (typically up to 15 kV peak-to-peak, >1 kW).

Feedstock gases were supplied via digitally controlled mass flow controllers (MFCs) equipped with pneumatic cut-off valves and calibrated with a bubble flow meter. The methane and hydrogen sulfide conversion system could operate under vacuum (sub-ambient, mbar range) or up to 2 bar absolute, controlled with a membrane pump, pressure valve, and capacitive gauge. All lines and connections in contact with H₂S and products were acid-resistant or Teflon-coated. Product gases were continuously monitored by Gas Chromatography (GC) equipped with TCD and FID detectors, and Mass Spectrometry (MS) when indicated.

Liquid or condensed products were collected in cold traps and analyzed by GC-MS. Where required, additional confirmation was performed by NMR spectroscopy. Bulk gas/reactor wall temperature was monitored with type-K thermocouples. Catalyst bed temperature was measured with an embedded thermocouple where indicated. All conversions, selectivity's, and yields are reported on a molar basis unless otherwise specified. Carbon+sulfur balance closure averaged 92-98% across experiments.

### Example 1

Effects of Ru nanoclusters supported on carbon black (Ru/CB) on methane and hydrogen sulfide reforming.

1 wt % Ru supported on carbon black (Vulcan XC-72) was prepared by wet impregnation of RuCl₃·xH₂O in water. The material was dried at 110° C. for 12 h and reduced under 5% H₂/N₂ at 300° C. for 3 h. The final catalyst was Ru nanoclusters supported on carbon black (Ru/CB).

### Reactor Conditions:

Catalyst loading: 0.5 g packed bed.
Feed: CH₄/H₂S (1:1 vol %), residence time=2.0 s.
Pressure: 1 atm. Bulk temperature: 450° C.
Plasma: 15 kV (peak-to-peak), ˜120 kHz, ˜1.2 kW.

### Results:

CH₄ conversion: 48%.
H₂S conversion: 67%.
Products: H₂=72 mol %; CS₂=20 mol %; (C₃S₂)ₓ=8 mol %.
Stability: No measurable deactivation over 12 h continuous run. XPS post-run showed Ru clusters remained metallic with limited sulfiding.
Interpretation: Ru/CB catalysts show high H₂ selectivity and strong sulfur tolerance under PC-H₂SMR conditions. H₂S conversion exceeds CH₄ conversion (1.4×ratio). The sulfur-bridged surface intermediates (S*—S*) on Ru sites assist CH₄ activation and limit coke formation.

### Example 2

Effects of Pd—Pt alloy nanoparticles on BN nanotubes (Pd—Pt/BNNTs) on methane and hydrogen sulfide reforming

Catalyst Preparation: 2 wt % Pd—Pt alloy (1:1 atomic ratio) on BN nanotubes via impregnation of PdCl2 and H2PtCl₆. Dried at 110° C., reduced in H2 at 350° C. for 2 h.

### Reactor Conditions:

Catalyst: 0.4 g bed.
Feed: CH4/H2S (1:1 vol %), residence time=1.5 s.
Bulk temperature: 480° C., 1 atm.
Plasma: 12 kV, ˜100 kHz.

### Results:

CH₄ conversion: 43%.
H₂S conversion: 61%.
Products: H₂=65%; CS₂=18%; (C₃S₂)ₓ=12%.
Stability: Maintained activity over 8 h with gradual increase in polymeric (C₃S₂)ₓ.
Interpretation: Pd—Pt alloy catalysts favor pathways to polymeric (C₃S₂)ₓ while maintaining good H₂ yields; BNNT support provides thermal and chemical robustness.

### Example 3

Effects of Ru—Ni alloy nanoparticles on TiO₂ (Ru—Ni/TiO₂) on methane and hydrogen sulfide reforming

Catalyst Preparation: Co-impregnation of RuCl₃·xH₂O and NiCl₂·6H₂O on TiO₂ (anatase). Total loading ˜5 wt % metals, Ru:Ni=3:2. Reduced in H₂ at 400° C. for 3 h.

### Reactor Conditions:

Catalyst: 0.5 g.
Feed: CH₄/H₂S (1:1 vol %), residence time=2.5 s.
Pressure: 1 atm; bulk temperature: 500° C.
Plasma: 18 kV, ˜110 KHz.

### Results:

CH4 conversion: 51%.
H₂S conversion: 74%.
Products: H₂=78%; CS₂=15%; (C₃S₂)ₓ=7%.
Stability: <5% decline in activity after 24 h operation.
Interpretation: Ru—Ni synergy on TiO₂ (Ru—Ni/TiO₂) improves CH₄ and H₂S conversions and H₂ selectivity, consistent with sulfur-bridged surface intermediates (S*—S*) proposed in the literature.

### Example 4

Effects of Co—Ni nanoparticles encapsulated in h-BN (Co—Ni@BN) on methane and hydrogen sulfide reforming.

Catalyst Preparation: 10 wt % Co—Ni alloy nanoparticles encapsulated in h-BN shells, prepared by deposition-nitridation method. Ground and sieved to 200-300 μm.

### Reactor Conditions:

Catalyst: 0.5 g.
Feed: CH₄/H₂S (1:1 vol %), residence time ≈2.0 s.
Bulk temperature: 470° C., 1 atm.
Plasma: 14 kV, ˜100 kHz.

### Results:

CH₄ conversion: 46%.
H₂S conversion: 63%.
Products: H₂=68%; CS₂=17%; (C₃S₂)ₓ=15%.
Durability: Encapsulation improved sintering resistance; maintained activity after accelerated thermal aging (900° C. inert ramp).
Interpretation: BN encapsulation shifts selectivity towards polymeric (C₃S₂)ₓ and enhances catalyst stability.

### Example 5

### Two-Stage Process: Example 4→Example 3 (Co—Ni@h-BN→Ru—Ni/TiO₂)

A feed comprising 50 vol % CH₄ and 50 vol % H₂S was contacted in a first DBD reactor containing Co—Ni nanoparticles encapsulated in h-BN at 470° C., 14 kV, ˜90 kHz, residence 2.0 s. The effluent was quenched to ≤5° C. to condense a first condensed stream comprising CS₂ and (C₃S₂)ₓ and to produce a hydrogen-rich gas stream. The gas stream was introduced into a second DBD reactor containing Ru—Ni (3:2, 5 wt %) on mesoporous TiO₂ at 500° C., 18 kV, ˜110 kHz, residence 2.5 s. Overall (two-stage) conversions were CH₄≈54-58% and H₂S≈76-82%, with a hydrogen selectivity of ≈72-76%. The combined condensed product from the inter-stage and final separators comprised (C₃S₂)ₓ≈20-22% and CS₂≈15-17% on a molar product basis. The specific plasma energy requirement was ≈0.90-0.98 kWh per Nm³ of hydrogen produced.

In the two-stage configuration, Stage 1 (Co—Ni@h-BN) efficiently generates S*—S* dimers, CS₂, and polymeric (C₃S₂)ₓ under plasma activation. Inter-stage condensation removes condensables that otherwise cause back-reaction and catalyst fouling. Stage 2 (Ru—Ni/TiO₂) converts residual CH₄ and H₂S into additional H₂, thereby increasing overall conversion and reducing specific energy consumption compared to the single-stage configuration.

### Example 6

### Plasma-Assisted Vs Thermal H₂SMR

Thermal Benchmark: Conventional thermal H₂S-CH₄ reforming at 900° C. (without plasma) over a commercial sulfide catalyst resulted in limited CH₄ conversion (38%), H₂S conversion (40%), producing mainly CS₂ at 600° C. with low H₂ selectivity (<40%). Since CS₂ is a toxic liquid, its formation at this temperature poses both safety concerns and an economic drawback due to the need for liquefaction.

Plasma-Assisted: Using catalysts from Examples 1-4 at 450-500° C., non-thermal plasma enabled higher CH₄ conversion (46-51%), H₂S conversion (61-74%) and significantly higher H₂ selectivity (65-78%). Importantly, polymeric (C₃S₂)ₓ coproducts were formed at <500° C., which are not produced in conventional thermal runs.

Interpretation: Non-thermal plasma provides non-equilibrium pathways that enable bond activation at reduced bulk temperatures, yielding higher H₂ and novel coproducts compared to high-temperature thermal H₂SMR.

Table 1 below summarizes preliminary plasma-catalytic reforming experiments conducted using different nanocatalysts under comparable reaction conditions, explained below.

TABLE 1
Catalyst Performance Data

| | CH₄ | H₂S | H₂ | CS₂ | (C₃S₂)ₓ | Energy Input |
|---|---|---|---|---|---|---|
| | Conversion | Conversion | Selectivity | Yield | Yield | (kWh/Nm³ |
| Catalyst System | (%) | (%) | (%) | (%) | (%) | H₂) |
| Ru nanoclusters/ | 48 | 67 | 72 | 20 | 8 | 0.95 |
| Carbon black | | | | | | |
| Pd—Pt/BN | 43 | 61 | 65 | 18 | 12 | 0.88 |
| nanotubes | | | | | | |
| Ru—Ni/TiO₂ | 51 | 74 | 78 | 15 | 7 | 1.02 |
| mesoporous | | | | | | |
| Co—Ni/BN | 46 | 63 | 68 | 17 | 15 | 1.00 |
| encapsulated | | | | | | |
| Two-Stage | 54-58 | 76-82 | 72-76 | 15-17 | 20-22 | 0.90-0.98 |
| Co—Ni@h-BN → | | | | | | |
| Ru—Ni/TiO₂ | | | | | | |

A system in accordance with the present disclosure may reduce methane (CH₄) and hydrogen sulfide emissions by converting the potent environmental pollutants into valuable products. A system in accordance with the present disclosure may reduce carbon dioxide emissions compared to conventional methane reforming, with potential emissions reductions in the range of 20-30 gCO₂ per MJ produced and if hydrogen sulfide sequestration carbon intensity is considered, the potential emissions reductions may be in the range of 10-20 gCO₂ per MJ.

The processes and systems described herein are oxygen-free, water-free, and carbon-neutral, generating hydrogen without CO₂ emissions and converting toxic H₂S into benign sulfur-rich carbon products. The resulting hydrogen is suitable for use as a clean fuel or chemical feedstock, while poly carbon subsulfide materials exhibit semiconducting properties (bandgap ≈2.4 eV) suitable for photovoltaic, optoelectronic, or advanced material applications.

Accordingly, the present disclosure provides an energy-efficient, environmentally benign route to hydrogen production that simultaneously valorizes hydrogen sulfide waste streams and methane, integrating plasma activation with robust sulfur-resistant catalysts.

The foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for converting methane and hydrogen sulfide to hydrogen and poly carbon subsulfide, the system comprising:
a non-thermal plasma reactor;
a first feed stream including methane;
a second feed stream including hydrogen sulfide;
a catalyst support material selected from boron nitride, carbon black, graphene, aluminum oxide (Al₂O₃), or titanium dioxide (TiO₂); and
a catalyst selected from Ru, Rh, Ir, Pd, Pt, Re, Mo, Ni, Co, W, and combinations thereof.

2. The system of claim 1, wherein an inlet molar ratio of the methane in the first feed stream to hydrogen sulfide in the second feed stream is between about 1:2 and 1:10.

3. The system of claim 1, wherein a reaction pressure of the reactor is in the range of sub-ambient to two bar absolute pressure.

4. The system of claim 1, wherein the non-thermal plasma reactor is configured to generate the non-thermal plasma by microwave, radio frequency (RF), dielectric barrier discharge (DBD), gliding arc discharge, or glow discharge methods.

5. The system of claim 1, wherein a reaction temperature within the reactor is in a range of from about 20 degrees Celsius to about 500 degrees Celsius.

6. The system of claim 1, wherein the catalyst includes a Ru nanocluster, and the support material is carbon black.

7. The system of claim 1, wherein the catalyst includes Pd and Pt nanoparticles and the support material is boron nitride nanotubes.

8. The system of claim 1, wherein the catalyst includes Ru nanoparticles, and the support material is hexagonal boron nitride (h-BN).

9. The system of claim 1, wherein the catalyst includes Ru and Ru—Ni nanoparticles, and the support material is titanium dioxide (TiO₂).

10. The system of claim 1, wherein the catalyst includes Pd nanoparticles, and the support material is titanium dioxide (TiO₂) and carbon nanocones.

11. The system of claim 1, wherein the catalyst includes Co—Ni nanoparticles, and the support material is hexagonal boron nitride (h-BN).

12. A method for producing hydrogen and poly carbon subsulfide, the method comprising:
providing a first feed stream including methane to a reactor;
providing a second feed stream including hydrogen sulfide to the reactor; and
reacting the first feed stream and the second feed stream in a non-thermal plasma in the presence of a catalyst to produce a product stream including hydrogen and poly carbon subsulfide;
wherein the catalyst comprises:
a catalyst support material selected from boron nitride, carbon black, graphene, aluminum oxide (Al₂O₃), or titanium dioxide (TiO₂); and
the catalyst is selected from Ru, Rh, Ir, Pd, Pt, Re, Mo, Ni, Co, W and combinations thereof.

13. The method of claim 12, further comprising providing the product stream to a separator and separating the product stream into a hydrogen stream and a poly carbon subsulfide stream.

14. The method of claim 13, further comprising, separating the product stream into a hydrogen stream and a poly carbon subsulfide stream by cooling the product stream to produce a condensed portion of the product stream.

15. The method of claim 13, wherein the separator separates the products stream into a hydrogen stream, a poly carbon subsulfide stream, and an unreacted gases stream that includes unreacted methane, and hydrogen sulfide, the method further comprising:
providing the unreacted gases stream to a second reactor;
reacting the unreacted gases stream in a second non-thermal plasma in the presence of a second catalyst to produce a second product stream including hydrogen and poly carbon subsulfide;
wherein the second catalyst comprises:
a second catalyst support material selected from boron nitride, carbon black, graphene, aluminum oxide (Al₂O₃) or titanium dioxide (TiO₂); and
the second catalyst is selected from Ru, Rh, Ir, Pd, Pt, Re, Mo, Ni, Co, W and combinations thereof.

16. The method of claim 15, further comprising providing the second product stream to a second separator and separating the second product stream into a second hydrogen stream and a second poly carbon subsulfide stream.

17. The method of claim 16, further comprising, separating the second product stream into a second hydrogen stream and a second poly carbon subsulfide stream by cooling the second product stream to produce a condensed portion of the second product stream.

18. The method of claim 15, wherein the catalyst includes Co—Ni nanoparticles, and the support material is hexagonal boron nitride (h-BN), and the second catalyst includes Ru and Ru—Ni nanoparticles, and the second support material is TiO₂.

19. The method of claim 12, further comprising preheating the first feed stream prior to providing the first feed stream to the reactor.

20. A catalyst on a support for converting methane and hydrogen sulfide to hydrogen and poly carbon subsulfide in the presence of a non-thermal plasma, the catalyst on a support comprising:
a catalyst support material selected from boron nitride, carbon black, graphene, aluminum oxide (Al₂O₃) or TiO₂; and
wherein the catalyst is selected from Ru, Rh, Ir, Pd, Pt, Re, Mo, Ni, Co, W and combinations thereof.
